(19) United States
(12) Patent Application Publication
(10) Pub. No.: US 2014/0226681 A1
(43) Pub. Date: Aug. 14, 2014

(54) CENTRALIZED TASK MANAGEMENT USING A ROUTER

(71) Applicant: QUALCOMM INCORPORATED, San Diego, CA (US)

(72) Inventor: Bharath GANDHI, Chennai (IN)

(73) Assignee: QUALCOMM INCORPORATED, San Diego, CA (US)

(21) Appl. No.: 13/765,530

(22) Filed: Feb. 12, 2013

(51) Int. Cl. H04L 12/911

(52) U.S. Cl. CPC H04L 47/783
USPC 370/468

(57) ABSTRACT

Embodiments include a method for downloading data (e.g., audio files, video files, etc.) to a router. In some embodiments, the method includes receiving, via a web server residing in the router, information identifying data to be downloaded over a network from a remote device. The method can also include initiating operations for downloading the data from the remote device. The method can also include receiving, in the router, data packets from the network, where some of the data packets include portions of the data. The method can also include identifying those data packets that include data portions, and extracting the data portions. The method can also include combining the data portions to form a data file, and storing the data file in the router.

### BACKGROUND

Embodiments of the inventive subject matter generally relate to the field of computer networking, and more particularly to computer network routing devices.

Today, information transfer is typically facilitated by a vast array of networks and the internet. Many networks are very complex and contain many components. One common component is the router. Routers act as a sorting and directing mechanism for the information transferred over the network. Information is typically transferred in the form of packets, which include address information and data. Upon receiving packets, routers analyze the address information to determine the packets' destinations. Upon determining the destinations, routers forward the packets to their appropriate destinations through the network.

Although many complex networks exist, a common type of network is the home network. A typical home network consists of a modem, a router, and one or more computing devices. The modem typically operates by modulating analog signals into digital signals (downstream) and modulating digital signals into analog signals (upstream). After receiving the signals, the modem transmits the signals to the router. The router analyzes packets contained in the signals, and transmits the packets to their appropriate destinations. Additionally, the router allows multiple computing devices to connect to the internet through a single modem.

### SUMMARY

Embodiments include a method for downloading data (e.g., audio files, video files, etc.) to a router. In some embodiments, the method includes receiving, via a web server residing in the router, information identifying data to be downloaded over a network from a remote device. The method can also include initiating operations for downloading the data from the remote device. The method can also include receiving, in the router, data packets from the network, where some of the data packets include portions of the data. The method can also include identifying those data packets that include data portions, and extracting the data portions. The method can also include combining the data portions to form a data file, and storing the data file in the router.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a network including a router according to some embodiments.

FIGS. 2a-2c depict a router and an external storage device according to some embodiments.

FIG. 3 depicts an example user interface according to some embodiments.

FIG. 4 is a block diagram illustrating a router, according to some embodiments.

FIG. 5 is a flow diagram illustrating operations for downloading content, according to some embodiments.

### DESCRIPTION OF EMBODIMENT(S)

The description that follows includes exemplary systems, methods, techniques, instruction sequences and computer program products that embody techniques of the present inventive subject matter. However, the described embodiments may be practiced without these specific details. In some instances, well-known instruction instances, protocols, structures, and techniques have been omitted for clarity.

Often times, users want to transfer data from the internet or other networks. For example, users may want to download large video files from internet-based video distributors. Alternatively, users may want to transfer large numbers of music files from internet-based music distributors. In either case, such data transfers can take significant time to complete. As a result, users may have to leave their computers running for long durations, waiting for data transfers to complete.

In accordance with some embodiments, the users may perform data transfers without maintaining a connection between a computing device and a network. For example, in some embodiments, a router allows users to initiate data transfers, and then disconnect their computing devices from the network. After users disconnect and power-down their devices, the router performs operations to complete the data transfers. As a result, users need not leave their computing devices running until downloads are complete. In some embodiments, the router can include memory storage for storing transferred data. Alternatively, the router can save transferred data to an external storage device.

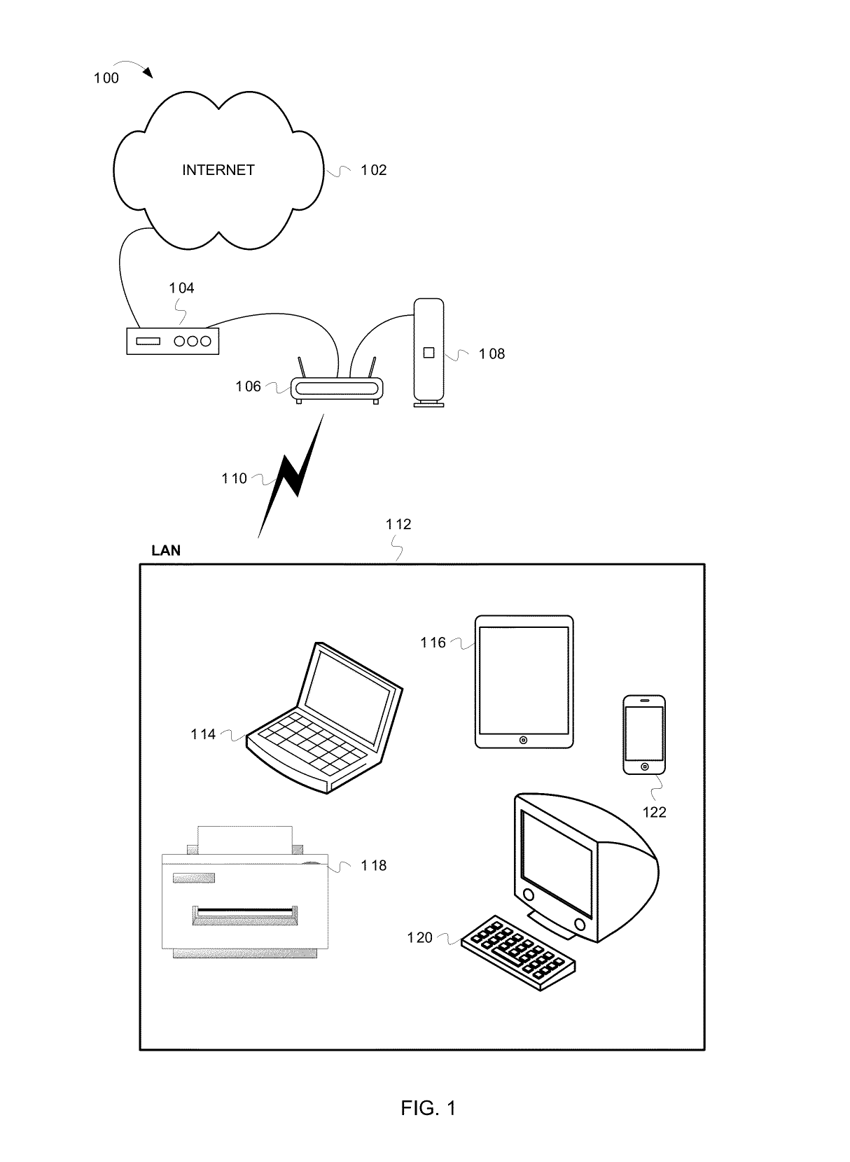

FIG. 1 depicts a network, according to some embodiments. In FIG. 1, the network 100 also includes a router 106, modem 104, an external storage device 108, and various computing devices such as a laptop computer 114, a tablet computer 116, a printer 118, a desktop computer 120, and a mobile phone 122.

In some embodiments, the router 106 allows users to initiate transfer operations via the computing devices (114, 116, 120, and 122), then enables those computing devices to disconnect from the network 100 before the transfer operations are complete. In such embodiments, the router 106 contains components to manage the download operations. In some embodiments, the router 106 contains one or more memory devices for storing the transferred data. In other embodiments, the router 106 can be coupled to an external storage device 108 for storing the transferred data.

As shown in FIG. 1, the router 106 is coupled to the modem 104, which is coupled to the internet 102. The modem 104 modulates signals going between the router 106 and the internet 102. In some embodiments, the router 106 can be physically connected to the modem 104 by a category 5e (cat 5e) cable, an RJ-45 cable, etc. In other embodiments, the router 106 can communicate wirelessly with the modem 104. In some embodiments, the modem 104 and the router 106 can be integrated into a single device.

The router 106 can receive data traffic from the local area network (LAN) 112 and route the traffic throughout the internet 102. The router 106 can also route traffic from the internet 102 (and networks) to devices in the LAN 112 and to the external storage device 108.

In some embodiments, the router 106 can communicate with devices in the LAN 112 using any suitable communication technology, such as Ethernet, Sonnet, wireless technologies, etc. In some embodiments, the router 106 can communicate with devices in the LAN 112 via powerline communication. Typically, homes and offices are wired with copper (or other metallic) wire to carry electricity to the different areas of the homes and offices. Powerline communication allows the router 106 and other devices to communicate over these preexisting power lines, potentially eliminating the need to install dedicated network cables. By operating at significantly higher frequencies than power distribution (20 to 200 kH versus 50 to 60 Hz), Ethernet communication can occur without interfering with power distribution. In some embodiments, the router 106 is capable of communicating using a plurality of technologies. For example, the router 105 may wirelessly communicate with some devices, while using powerline to communicate with other devices.

As shown, the router 106 is connected to the external storage device 108, which can store data involved in data transfers controlled by the router 106. The external storage device 108 can include magnetic disk memory, flash memory, battery-baked random access memory, or any other suitable memory technology. Alternatively, in some embodiments, the router 106 can have internal storage, such as semiconductor memory (not shown), magnetic disc memory (not shown), etc. In some embodiments, the router 106 can be physically connected to the external storage device 108 by a Universal Serial Bus (USB) cable, FireWire cable, etc. In other embodiments, the router 106 can communicate wirelessly with the external storage device 108 (e.g., where the external storage device 108 resides on the LAN 112). Additionally, in some embodiments, the external storage device 108 can connect directly to the router 106 (e.g. the external storage device 108 can be a USB flash drive).

The network 100 further comprises a plurality of computing devices making up a local area network (LAN). In some embodiments, the router 106 can be physically connected to one or more of the computing devices (not shown). In other embodiments, the router can communicate wirelessly 110 with one or more of the computing devices.

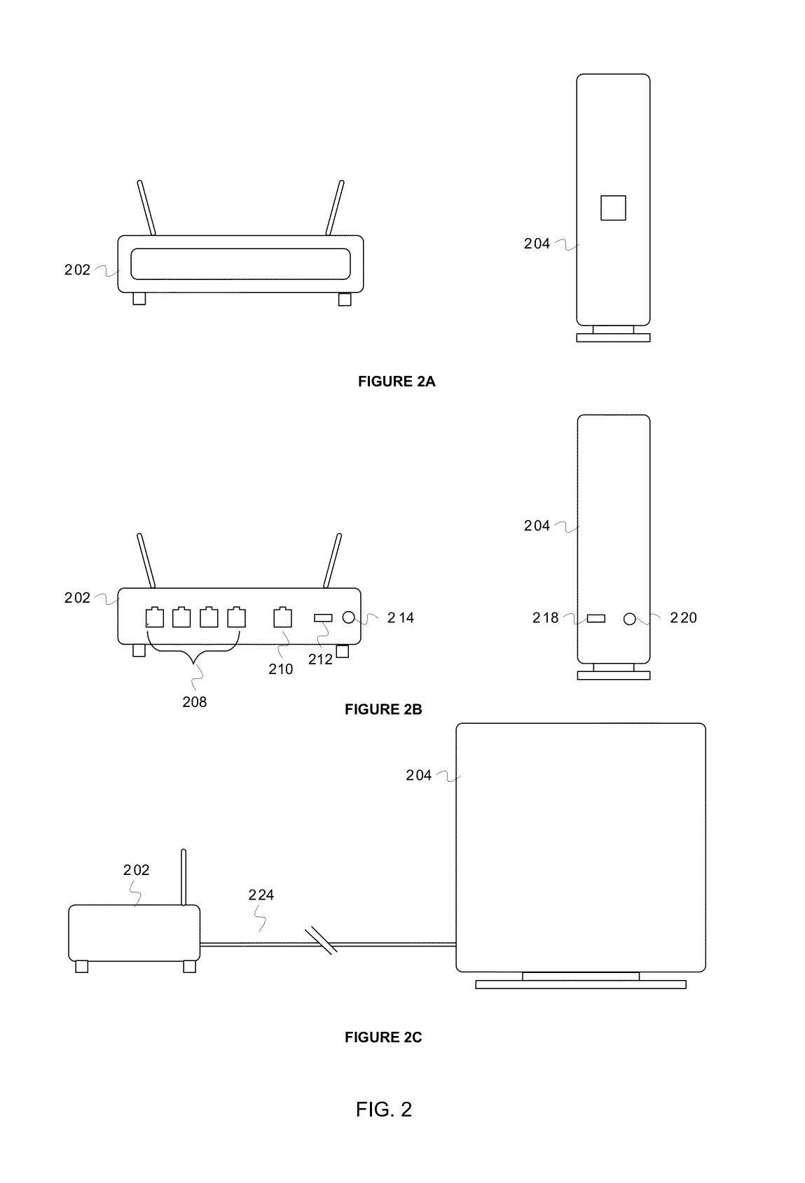

FIGS. 2a-2c depict one embodiment of a router 202 and an external storage device 204 according to some embodiments. FIG. 2a is a front view of a router 202 and an external storage device 204.

FIG. 2b is a rear view of a router 202 and an external storage device 204. In some embodiments, the router 202 can have a plurality of local area network (LAN) connection ports 208. In some embodiments, the router 202 can have a modem connection port 210. In some embodiments, the router 202 can have one or more external storage connection ports 212. The router 202 also has a power supply input 214. In FIG. 2b, the external storage device 204 has a USB connection port 218 and a power supply input 220.

FIG. 2c is a side view of a router 202 and an external storage device 204. As depicted, the router 202 is connected to the external storage device 204 by a cable 224. In some embodiments, the cable 224 can be a USB cable, a FireWire cable, etc. Additionally, in some embodiments, the external storage device 204 can connect directly to the router 202 (e.g. a USB flash drive).

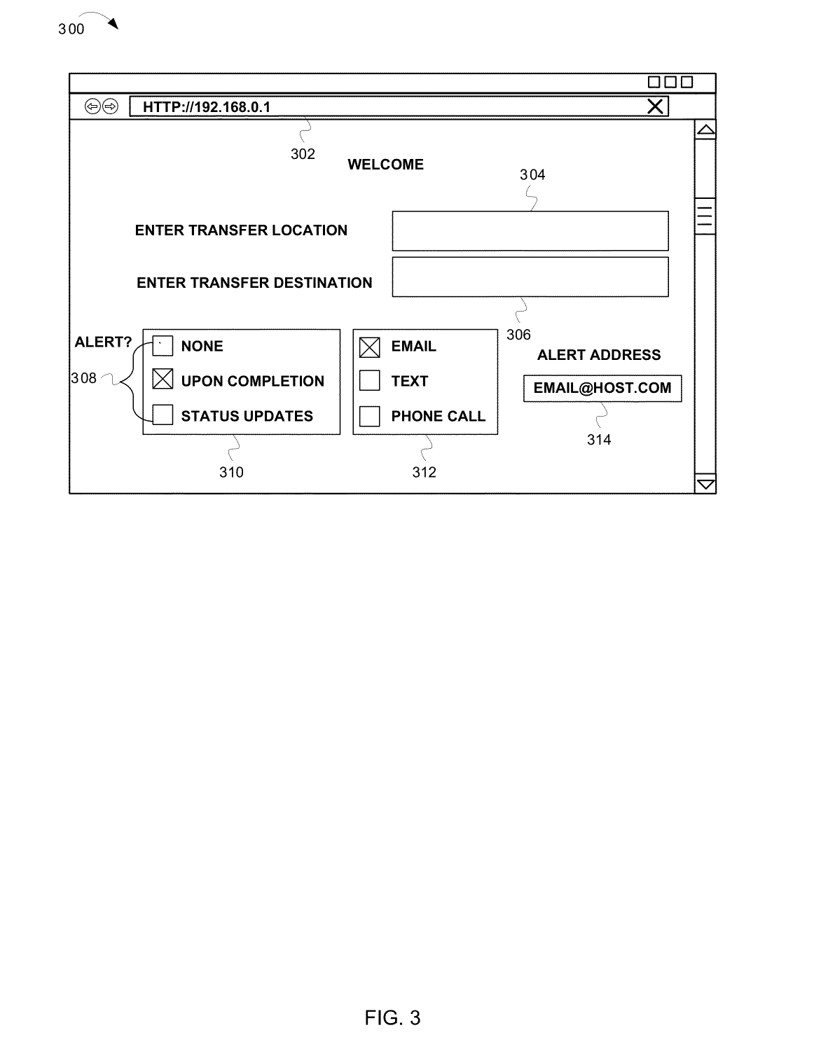

In some embodiments, the router provides a graphical user interface that enables users to configure operations for transferring data from the internet and other networks. FIG. 3 depicts an example user interface 300 with which a user may configure a router to autonomously transfer data from remote network devices. In some embodiments, the router hosts a webpage that includes the user interface 300. In such embodiments, a user can access the webpage by browsing to a URL at which the webpage is available. The webpage can include the user interface 300, and can present options for downloading data over a network. The options can relate to initiating data transfers (e.g., data downloads from the internet), canceling data transfers, pausing data transfers, checking status of data transfers, configuring file path destinations for data transfers, etc. The user interface 300 allows the user to control data transfers by the router without having a computing device operating and connected to the local area network.

In some embodiments, the user interface 300 allows the user to initiate a data transfer by entering a location from which data is to be transferred in a “transfer location” field 304. In some implementations, a transfer location can be a web URL, a file path, a bit torrent file, etc. Additionally, in some embodiments, the user interface 300 allows the user to select a transfer operation's destination file path (i.e., a location at which the data will be stored after receipt) by entering the destination file path in a “transfer destination” field 306. In some embodiments, the user interface 300 can present the user with a mechanism to control bandwidth allocation between the transfer process and normal routing traffic. For example, during high traffic periods (e.g. during business hours), the user can configure the router to devote only 30% of its bandwidth allocation to transfer operations. During low traffic periods (i.e. at night), the user can configure the router to allocate a greater bandwidth to transfer operations.

In some embodiments, the router can also provide alerts. Such alerts can allow a user to select how, if at all, to be alerted upon the occurrence of specified events. For example, a user may wish to be notified upon completion of a download or an upload. Alternatively, a user may wish to receive status updates pertaining to data transfer operations. In some embodiments, the user interface 300 can allow the user to configure alert settings in a manner similar to setting transfer location and transfer destination. In such embodiments, the user interface 300 can provide input fields for selecting an “alert upon” feature 310, an “alert type” field 312, an “alert address” field 314, etc. In some embodiments, the user interface 300 can present the user with a plurality of checkboxes 308 or other options for configuring the alert settings. As depicted in FIG. 3, the user has selected the checkbox 308 to be alerted upon completion (as indicated by the “X”), by sending an email alert (“alert type” field 312), to the provided email address (email@host.com entered in the “alert address” field 314).

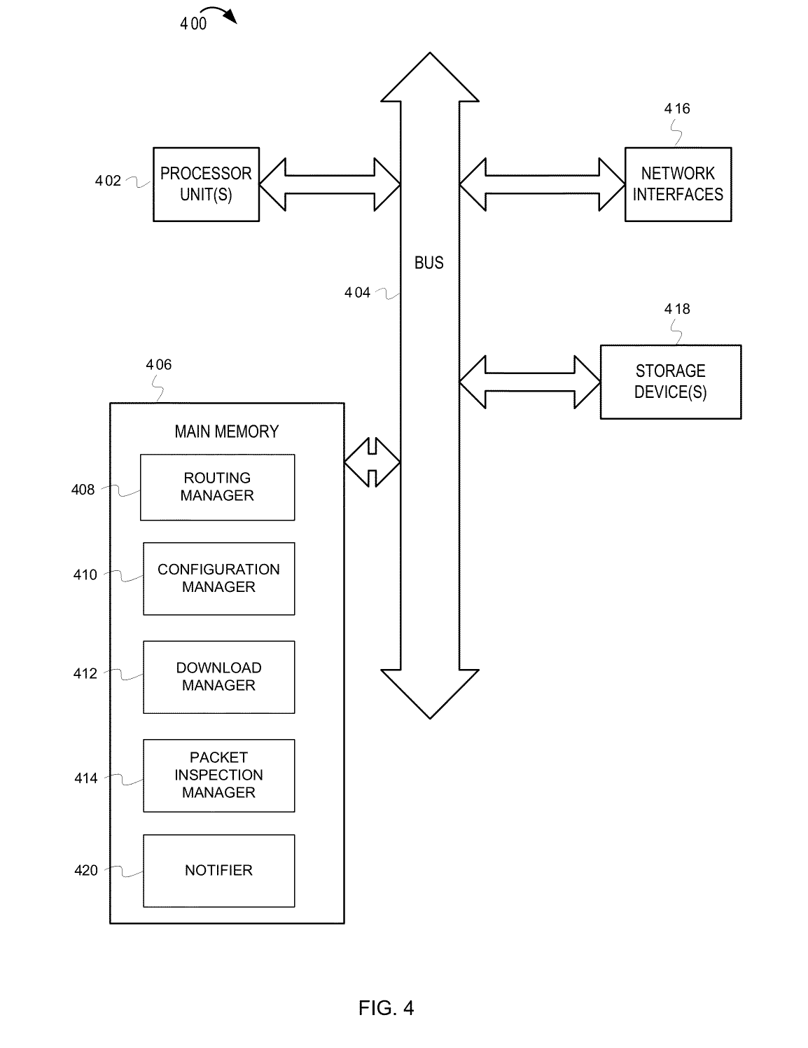

FIG. 4 is a block diagram illustrating an architecture for a router 400, according to some embodiments. In some implementations, the router 400 is node between two or more networks (e.g., a LAN and a WAN) that receives, processes, and routes packets associated with the networks. For example, the node can be a router/gateway of a LAN (e.g., LAN 112 shown in FIG. 1). The router 400 includes a processor unit 402 (possibly including multiple processors, multiple cores, multiple nodes, and/or implementing multi-threading, etc.). The router 400 includes a memory unit 406. The memory unit 406 can be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable storage media. The router 400 also includes a bus 404 (e.g., PCI, ISA, PCI-Express, HyperTransport®, InfiniBand®, NuBus, AHB, AXI, etc.), and network interface(s) 416 that include at least one of a wireless network interface (e.g., a Bluetooth interface, a WLAN 802.11 interface, a WiMAX interface, a ZigBee® interface, a Wireless USB interface, etc.) and a wired network interface (e.g., an Ethernet interface, a powerline communication interface, etc.).

Any one of these functionalities can be partially (or entirely) implemented in hardware and/or on the processor unit 402. For example, the functionality can be implemented with one or more application specific integrated circuits, one or more system-on-a-chip (SoC), or other type of integrated circuit(s), in logic implemented in the processor unit 402, in a co-processor on a peripheral device or card, in a separate processor and/or memory implemented within the network interface 416, etc. Further, realizations can include fewer or additional components not illustrated in FIG. 4 (e.g., video cards, audio cards, additional network interfaces, peripheral devices, etc.). The processor unit 402, the memory unit 406, and the network interfaces 416 are coupled to the bus 404. Although illustrated as being coupled to the bus 404, the memory unit 406 can be coupled to the processor unit 402.

In FIG. 4, the router 400 includes a routing manager 408. In some embodiments, the routing manager 408 can perform routing functions. For example, the routing manager 408 can detect receipt of data packets, determine the appropriate destination for the data packets by analyzing the data packets' address information, and forward the data packets along to their destinations. In some embodiments, the routing manager includes one or more routing tables and other routing information (not shown).

As shown, the router 400 includes a configuration manager 410. In some embodiments, the configuration manager 410 configures data transfer operations. In some embodiments, a user may input data transfer information in the user interface (discussed in FIG. 3). In such embodiments, the configuration manager 410 can receive data transfer instructions identifying the file to be downloaded or uploaded.

In FIG. 4, the router 400 includes a data transfer manager 412. The data transfer manager 412 controls operations for saving data. In some embodiments, the data transfer manager 412 can save the data to an external storage device. The external storage device can be volatile or non-volatile memory, such as semiconductor RAM, flash memory, magnetic disk, optical media, etc. In other embodiments, the data transfer manager 412 can save the data to internal storage device(s) 418. Such an internal storage device(s) can be volatile or non-volatile memory, such as semiconductor RAM, flash memory, magnetic disk, optical media, etc. In some instances, when received, the data has been divided into a number of parts that must be integrated to reconstitute the data. The data transfer manager 412 can combine the transfer data to form a file. The data transfer manager 412 can support any suitable file format, such as MPG, MP3, JPG, etc.

In some embodiments, the data transfer manager 412 can also allow multiple users to manage data transfers without affecting use of the router 400 by other users. In some embodiments, the data transfer manager 412 can send notifications to a notifier 420. In turn, the notifier 420 can perform a notification selected by the user. For example, in some embodiments, the notifier 420 can send email notifications, text notifications to a mobile device, notifications to a laptop/computer workstation, console log, etc.

In FIG. 4, the router 400 includes a packet inspection manager 414. In some embodiments, the packet inspection manager 414 parses the packets passing through the router 400 and collects download links. The packet inspection manager 414 can also determine which packets are associated with a data transfer, as opposed to traffic that is not associated with a data transfer. Additionally, in some embodiments, the packet inspection manager 414 can regulate the bandwidth allocated to the data transfer. For example, if there is significant data traffic not associated with the data transfer, the packet inspection manager 414 can limit bandwidth allocated to the data being transferred. Additionally, the packet inspection manager 414 can increase the bandwidth allocated to the data being transferred if there is little non-transfer traffic. Alternatively, in some embodiments, the bandwidth control can be static. In such embodiments, the user may be able to dictate bandwidth allocated to the data transfer. The packet inspection manager 414 can enforce the bandwidth limitations dictated by the user.

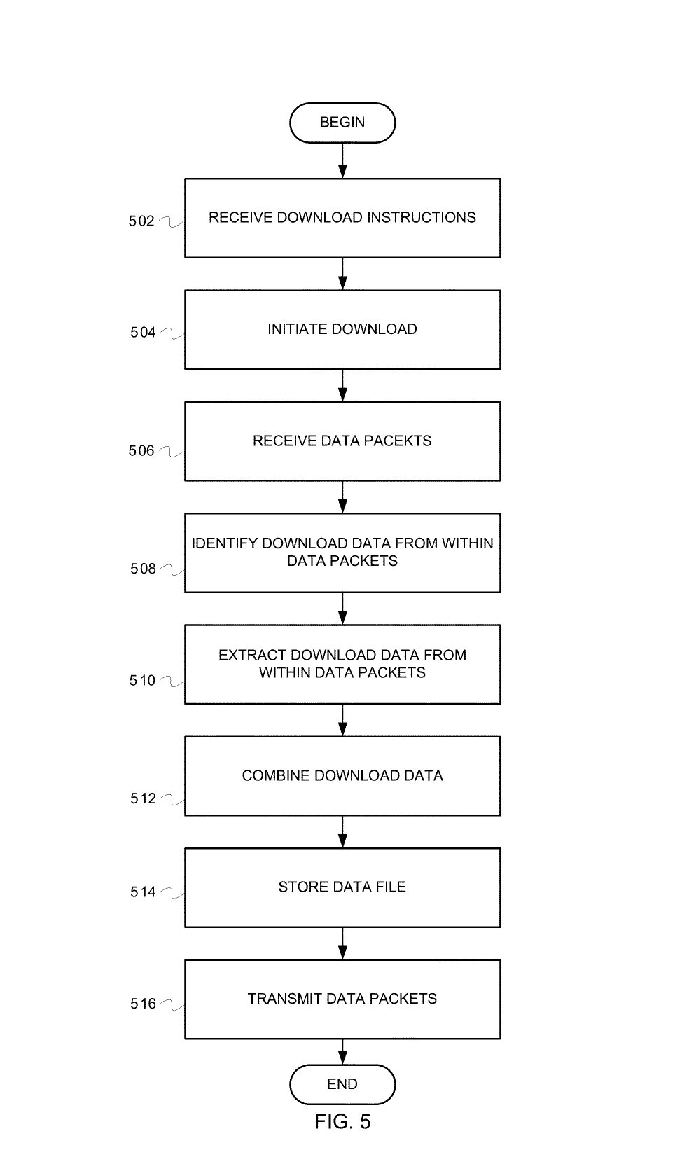

FIG. 5 is a flow diagram illustrating operations for transferring data, according to some embodiments. The flow begins at block 502. At block 502, data transfer instructions are received. In some embodiments, the configuration manager receives data transfer instructions via the user interface. In some embodiments, the data transfer instructions can include a URL with which the file can be downloaded, a bit torrent file, a directory file path, etc. The flow continues at block 504.

At block 504, the data transfer is initiated. In some embodiments, the configuration manager initiates the data transfer. In such embodiments, the configuration manager accesses the download data using the URL, obtains the bit torrent file, accesses a directory file path, etc. The flow continues at block 506.

At block 506, data packets are received. In some embodiments, the packet inspection manager receives the transfer data in form of data packets. After receiving the data packets, the packet inspection manager can inspect the data packets to determine which data packets are associated with the data transfer and which packets are network traffic unrelated to the transfer. The flow continues at block 508.

At block 508, download data is identified in the data packets. In some embodiments, the packet inspection manager conducts a deep packet inspection, in which the packet inspection manager inspects the packets at the application layer, to determine the characteristics of the data packets. In such embodiments, the packet inspection manager determines whether the data packets are associated with the download file. For packets that are not associated with the download data, the router transmits them on toward their destinations. The flow continues at block 510.

At block 510, data is extracted from within the data packets. For example, the download manager can extract the download data from within the data packets. The flow continues at block 512.

At block 512, the data is combined. In some embodiments, the download manager combines the transfer data into one or more files. The flow continues at block 514.

At block 514, the data file is stored. In some embodiments, the download manager stores the data file to the storage device. In such embodiments, the storage device can be an external storage device or an internal storage device. Additionally, the storage device can contain volatile or non-volatile memory. The flow continues at block 516.

At block 516, data packets are transmitted. In some embodiments, the routing manager facilitates transmission of data packets that are unrelated to the download. In such embodiments, the routing manager analyzes the address information contained in the data packets to determine their destinations. In turn, the routing manager forwards the data packets along to their destinations. From block 516, the flow ends.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a computer-readable storage device having stored thereon instructions, which may be used to program a computer system (or other electronic device(s)) to perform a process according to embodiments, whether presently described or not, since every conceivable variation is not enumerated herein. A computer readable storage device includes any mechanism for storing instructions (e.g., software, processing application) readable by a computing device (e.g., a computer, processor, router, etc.). The computer-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the internet using an internet Service Provider).

While the embodiments are described with reference to various implementations and exploitations, it will be understood that these embodiments are illustrative and that the scope of the inventive subject matter is not limited to them. In general, techniques for downloading data by a router as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A routing device configured to receive and transmit data, the routing device comprising:
a processor;
a routing manager configured to
detect receipt of data packets via a network interface;
transmit each of the data packets to a network destination;
a configuration manager configured to receive, as a result of input to a webpage, data transfer information identifying data to transfer over the network interface;
a download manager configured to control operations for transfer of the data from a remote device over the network interface;
a packet inspection manager configured to inspect the data packets and identify certain of the data packets that include the data; and
a storage device configured to store the data in response to operations of the download manager.

2. The routing device of claim 1, wherein the configuration manager is further configured to receive, via the webpage, user input indicating an amount of bandwidth to be allocated for the transfer of the data packets.

3. The routing device of claim 1, wherein the packet inspection manager is further configured to dynamically control bandwidth allocation for the transfer of the data.

4. The routing device of claim 1, further comprising:
a web server to provide the webpage.

5. The routing device of claim 1, where the download manager is further configured to transmit the data to a remote device in communication with the routing device.

6. The routing device of claim 1, further comprising:
a notification manager configured to transmit an email notification indicating that transfer of the data is complete.

7. The routing device of claim 1, further comprising:
a notification manager configured to transmit a short message service (SMS) message indicating download of the data packets is complete.

8. The routing device of claim 1, wherein the download manager is further configured to combine portions of the data to form a data file.

9. A method for downloading data to a router, the method comprising:
receiving, via a web server onboard the router, download information identifying data to be downloaded over a network from a remote device;
initiating operations for downloading the data from the remote device;
receiving, in the router, data packets from the network, wherein certain ones of the data packets include a portion of the data;
identifying the certain ones of the data packets that include the portion of the data;
extracting the portion of the data from the certain ones of the data packets;
combining the extracted portions of the data to form a data file; and
storing, in a storage device coupled to the router, the data file.

10. The method of claim 9, further comprising:
receiving, via the web server, user input indicating an amount of bandwidth of the router to be allocated to processing the data to be downloaded.

11. The method of claim 10, further comprising:
dropping at least one of the data packets that does not include any of the portions of the data, the dropping to provide more bandwidth to processing to the data to be downloaded.

12. The method of claim 9, further comprising:
regulating, based on a volume network traffic, an amount of bandwidth of the router to be allocated for operations for downloading the data.

13. The method of claim 9, further comprising:
transmitting the data file to one or more remote media playback devices that are in communication with the router.

14. The method of claim 9, further comprising:
transmitting an email notification indicating download of the data file is complete.

15. The method of claim 9, further comprising:
transmitting a short message service message (SMS) notification indicating download of the data file is complete.

16. The method of claim 9, further comprising:
transmitting a multimedia messaging service message (MMS) notification indicating download of the data file is complete.

17. One or more computer-readable storage devices including instructions for downloading data to a router, the instructions which when executed by a processor cause the processor to perform operations comprising:
receiving, via a web server onboard the router, download information identifying data to be downloaded over a network from a remote device;
initiating operations for downloading the data from the remote device;
receiving, in the router, data packets from over the network, wherein certain ones of the data packets include portions of the data;
identifying the certain ones of the data packets that include portions of the data;
extracting the data from the ones of the data packets;
combining the data to form a data file;
storing the data file in a memory device in the router; and
transmitting some of the data packets to destinations on the network.

18. The one or more computer-readable storage devices of claim 17, the operations further comprising:
receiving, via the web server, user input indicating an amount of bandwidth of the router to be allocated for the operations for downloading data.

19. The one or more computer-readable storage devices of claim 17, the operations further comprising:
dropping at least one of the data packets that does not include the portions of the data, the dropping to provide bandwidth to processing the data.

20. The one or more computer-readable storage devices of claim 17, the operations further comprising:
regulating, based on a volume network traffic, an amount of bandwidth of the router to be allocated for operations for processing the data.
